(19) United States
(12) Patent Application Publication
(10) Pub. No.: US 2003/0191612 A1
(43) Pub. Date: Oct. 9, 2003

(54) Integrated virtual product or service validation and verification system and method

(76) Inventor: Muchiu Chang, Lung-Tan (TW)

Correspondence Address: TROXELL LAW OFFICE PLLC, SUITE 1404, 5205 LEESBURG PIKE, FALLS CHURCH, VA, 22041, US

(21) Appl. No.: 10/407,174

(22) Filed: Apr. 7, 2003

(30) Foreign Application Priority Data
Apr. 9, 2002 (TW) 91107122

(51) Int. Cl. G06F 17/10

(52) U.S. Cl. 703/2

(57) ABSTRACT

The present invention discloses an integrated virtual product or service validation and verification system and method which are to transfer the relationship between the product characteristics and market into mathematical models, and calculate the concerned characteristics of various design options based upon mathematical theory to make decision. The decision making can be an integrated design trade-off for an optimal design, resource allocation and customer service whose goal is to achieve the maximal merit for both the buyer and vendor.

### BACKGROUND OF THE INVENTION

(1) Field of the Invention

The present invention generally relates to an integrated virtual product or service validation and verification system and method which are to transfer the relationship between the product characteristics and market into mathematical models, and calculate the concerned characteristics of various design options based upon mathematical theory to make decision.

(2) Description of the Prior Art

The prior art of this invention are as following:

1. “Monte Carlo Methods in Reliability Engineering” by A. Goldfeld & A. Dubi, Quality & Reliability Engineering International, vol. 3, pages 83-91, 1987.

2. “A Monte Carlo Study of Integrated Logistic Support Trade-off at early System Design Phase”, Univ. of Cambridge, September 1999.

3. “Using Life Cycle Revenue Loss and Monte Carlo Simulation as a Prior and Direct Assessment of Consequences of unwished Events”, MuChiu Chang and J. D. Lewins, Annals of Nuclear Energy, vol. 25, No. 1-3, page 117-127, 1998

4. U.S. Pat. No. 6,345,239, “Remote demonstration of business capability in an e-commerce environment” by Bowman-Amauah & Michel K., Feb. 5, 2002.

5. U.S. Pat. No. 6,348,358, “Simulation system using model” by Hiramatsu, et al. Oct 16, 2001.

6. ROC patent No. 445422 “Software Simulation Testing System for North and South Bridge Circuit” (VIA Technology), Jul. 02, 2001 ∘

7. ROC patent No. 440797, “Automatic Testing Platform with Simulation Testing Function and Method of the Same” (Institute for Information Industry), Jun, 02, 2001.

8. ROC patent No. 43721, the system and method of determining general virtual time in an optimal parallel discrete event simulation, Steven Bush (General Electric Co. Ltd.), May 25, 2001 ∘

When considering system design trade-off, we should not only consider the customer's requirements for function and performance, but also consider the merit and risk of the product ownership. This is the key point to persuade customers to buy the product. Moreover, the vendor's merit and risk are another important concerns. Thus, designer should not only pursuit high performance, high profit, low cost and low risk, but also should reduce the cost and risk of the product ownership. However, these concerns usually contradict with each other and should be traded off to reach a balance as in FIG. 1. From our experiences, we learn that the trade-off at the product concept design phase imposes deterministic influence on whether the product can be successful in the market. But at this early stage, no actual object is available for performing trade-off study, especially for the trade-off between resource allocation, risk and merit. Merit is a dynamic function of design, market requirements, integrated logistic support and resource allocation, while performance and functionality is a function of market requirements and design. The performance and functionality trade-off is driven by market analysis as in FIG. 2, which includes:

1. Market requirements for the product features, such as function, reliability, maintainability, safety, . . . etc.

2. Designer's resource requirement for fulfillment of the product features and requirements, such as existing techniques, allied vendor, integrated logistic support, . . . etc.

3. Market requirements for customer service.

4. Enterprise resource requirements for fulfilling the vendor's commitment in customer service, which includes:

A. The customer service originates from product design itself.

B. The customer service originates from the customers.

5. Market strategy.

The merit trade-off is driven by reliability design as in FIG. 3. The object of customer service infrastructure and supply chain are to remedy the product's inability to fulfill the customer's need, meanwhile such a inability may cause the cost and risk of ownership and damage the merit of the customer. Vendor also suffers from the problems of cost and risk in allocating resources in customer service and supply chain. These driven factors all affect the balance in FIG. 1.

When performing integrated trade-off at the conceptual design phase, we have the following difficulties:

1. There is no actual object available for demonstrating product's performance, function and life cycle characteristics. The present solution is to build some small amount of prototypes and deploy them to a small scale market to get the feedback data to improve the design and customer service infrastructure. The cost of product development is very high while the schedule is very long. Thus, it would be difficult to validate and verify (V&V) the product's market adaptability and competitiveness and deploy the product to the market within a short schedule in a rapid change market.

2. It would be difficult to quantitatively assess the risk in customer service and market interaction after the deployment.

3. Even with prototype V&V, due to the diversity and local characteristics, it would be difficult to get the whole picture from the local market V&V results.

4. The market demand and supply have dynamic and stochastic uncertainty which can hardly be quantitatively demonstrated in a laboratory or a local market experiment.

5. Customer's merit and risk of owning the product cannot be quantitatively assessed at this stage.

According to our experiences, the traditional design approach follows the high risk iteration as shown in FIG. 4. This is a “fly-failed-fix-fly” approach. When settling down the system design and specification in accordance with the market requirement analysis results, we build some prototypes directly and put it to the function and performance validation and verification. If any defect in the design or specification were found during V&V, the engineering changes to the design or specification can cause great impact to the budget and schedule. Moreover, if any product defect, problems in customer service or supply chain, inappropriate resource allocation or vendor's liability to the customer loss should happen and require product recalled for design changes after market deployment, it would cause huge impact to the vendor. All these situations are difficult to be quantitatively assessed at the early conceptual design stage. Those prior arts do not consider the influence of performance, risk and merit simultaneously upon the product's market competitiveness at the conceptual design stage. Therefore, we try to transfer the relationship between the product's design concepts, operational mechanism, specification and market characteristics into mathematical models, and, by calculating the features of various design options, such as performance, life cycle features, . . . etc., perform integrated design trade-off to bring maximal merit for both the buyer and vendor. At first, by adjusting the models and parameters which represent the design and specification of a product, we may trade off among the design options and validate and verify the balance shown as in FIG. 1, then we can start to build prototypes for actual validation and verification, as the low risk iteration shown in FIG. 4. This may reduce the risk of having failure during V&V and market deployment and is a “try-at-home-before-actually-go” approach. Also, we may expect to extend this method to some kind of specification certification mechanism similar to ISO 9000s' as shown in FIG. 5.

There are problems in the above prior art:

1 The first prior art only uses Monte Carlo method to assess system reliability and nothing else.

2 The second and third prior arts are our PHD researches which perform integrated logistic support trade-off without tuning the system performance and considering its influence on the integrated merit, while the market interaction with specification is also not considered.

3 The 4^{th} prior art aims to provide integrated network solution for e-commerce, but its simulation is based on real equipments or prototypes. By hiring real equipments and software and running the patented simulation programs on those hired equipments, the manager can test all the system's features and merit and then decide whether to start the procurement process. But hiring equipments for a trial also has risk in cost and schedule. If we did such a trial hiring for many times, the impact of schedule delay would be very large while repeated hiring itself is also costly.

4 The 5^{th} to 8^{th} prior arts all concern the performance optimization only, while other factors, such as production, supportability, reliability, maintainability, safety, merit, . . . etc., cannot be considered during the optimization. Also, dedicated simulation environment and interface need to be developed, once the studied object is changed, all the simulation environment and interface should be changed accordingly, which cause cost and schedule impacts.

The superior feature of our invention to the first three prior arts is to take into consideration of performance to form an integrated trade-off.

When comparing with the 4^{th} prior art, our superior feature is to perform the integrated system design trade-off by changing the mathematical models and parameters to perform repeated computations. The cost and time consumption of changing the mathematical models and parameters to perform repeated computations are much less than those of said hiring trail.

The superior feature of our invention over the 5th to the 8th prior arts is to bring in the factors of customer service, integrated logistic support and merit for an integrated trade-off.

### SUMMARY OF THE INVENTION

Accordingly, the primary object of the present invention is to perform integrated trade-off by mathematical modeling and model computation instead of actually building test objects. At the conceptual design phase, by modeling the relationship between the features of design options and the market demand and then changing the models and parameters accordingly, we may study the features of various design options under various customer demand loads so that we may demonstrate the life cycle feature of design options, such as performance, reliability, safety, merit, . . . etc., after market deployment and perform an integrated trade-off to make both the customers and vendors reach maximal merit.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a diagram depicting the balance of various design concerns according to the present invention.

FIG. 2 is a diagram depicting how market survey drives product performance optimization according to the present invention.

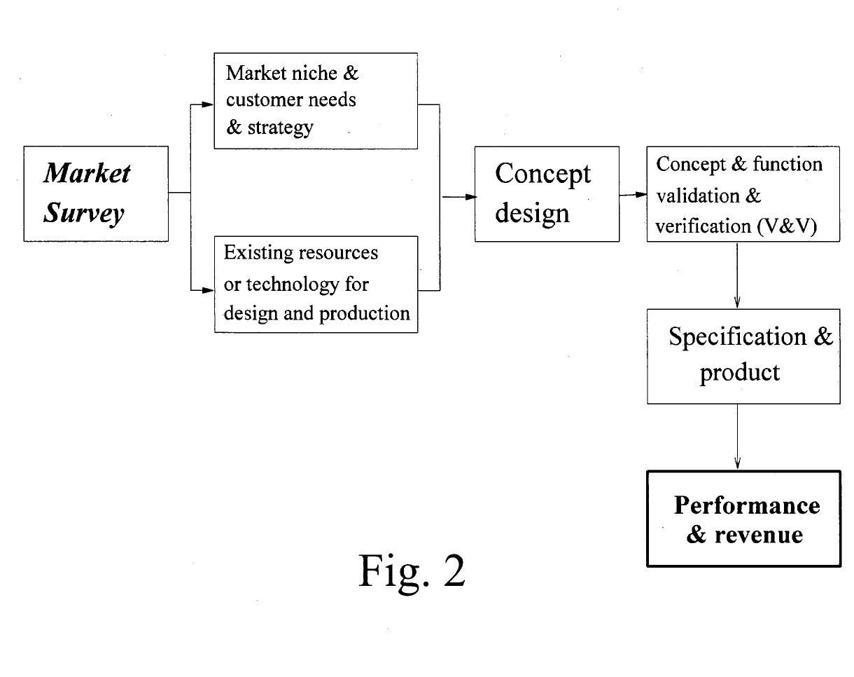

FIG. 3 is a diagram depicting how reliability design drives merit trade-off according to the present invention.

FIG. 4 is a diagram depicting the trade-off activities in the product's life cycle according to the present invention.

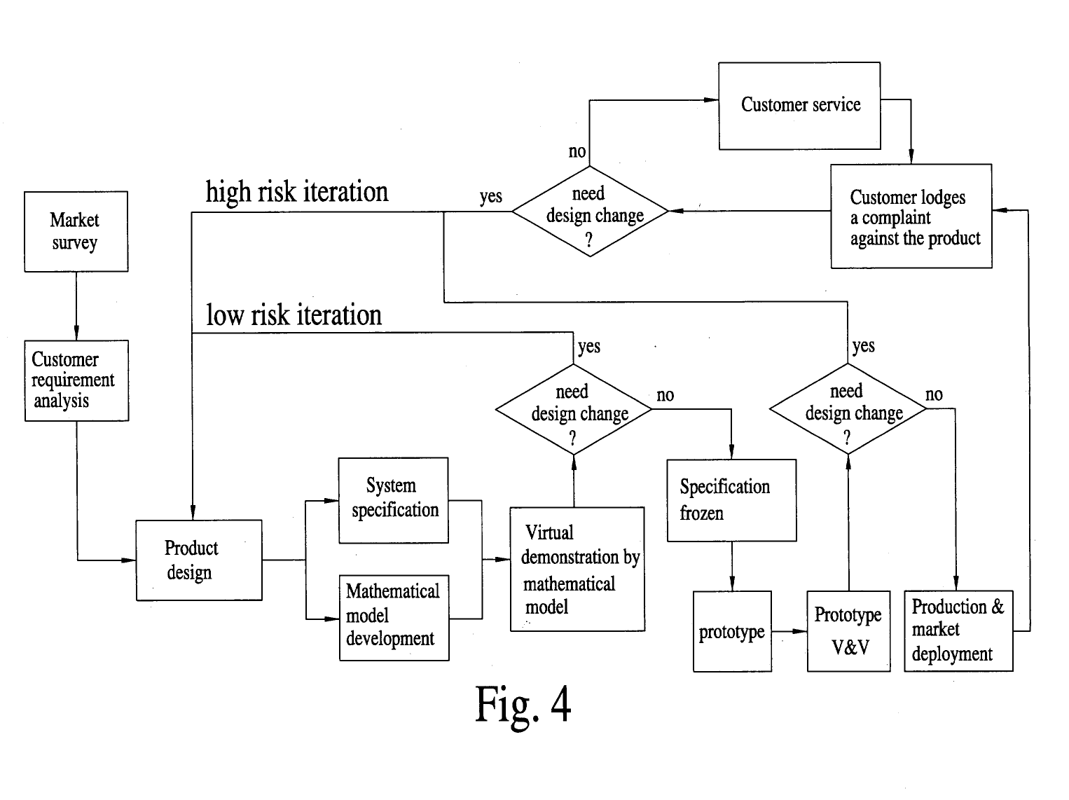

FIG. 5 is a diagram depicting the virtual validation and verification mechanism for a product's specification according to the present invention.

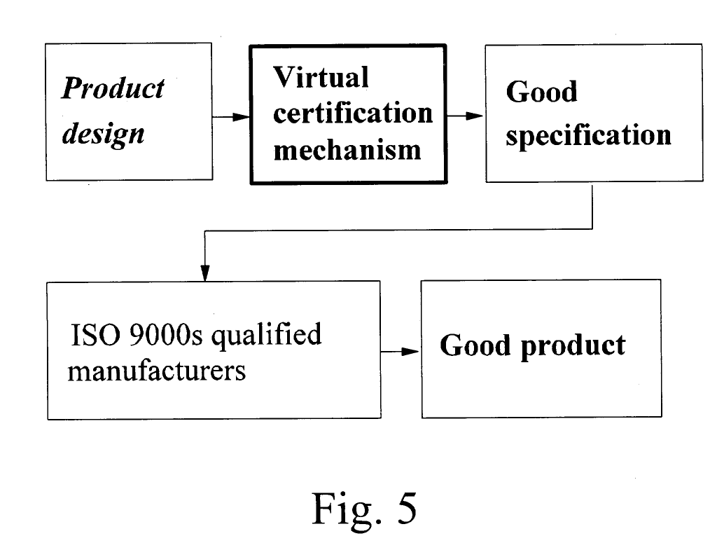

FIG. 6 is a diagram depicting a 3-tier network infrastructure according to the present invention.

FIG. 7 is a diagram depicting an embodiment of network data transaction history according to the present invention.

FIG. 8 is a diagram depicting an embodiment of system life according to the present invention.

FIG. 9 is a diagram depicting the bandwidth trade-off results according to the present invention.

FIG. 10 is a diagram depicting the performance trade-off results according to the present invention.

FIG. 11 is a diagram depicting the life cycle features trade-off results according to the present invention.

FIG. 12 is a diagram depicting the steps of the method according to the present invention.

### DETAILED DESCRIPTION OF THE INVENTION

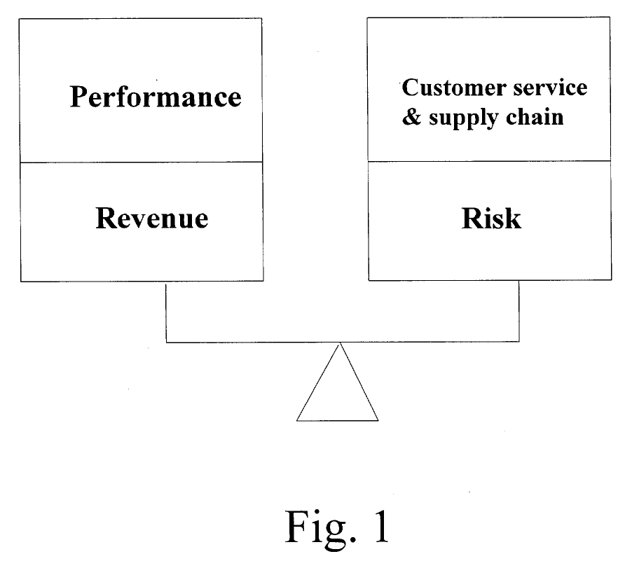

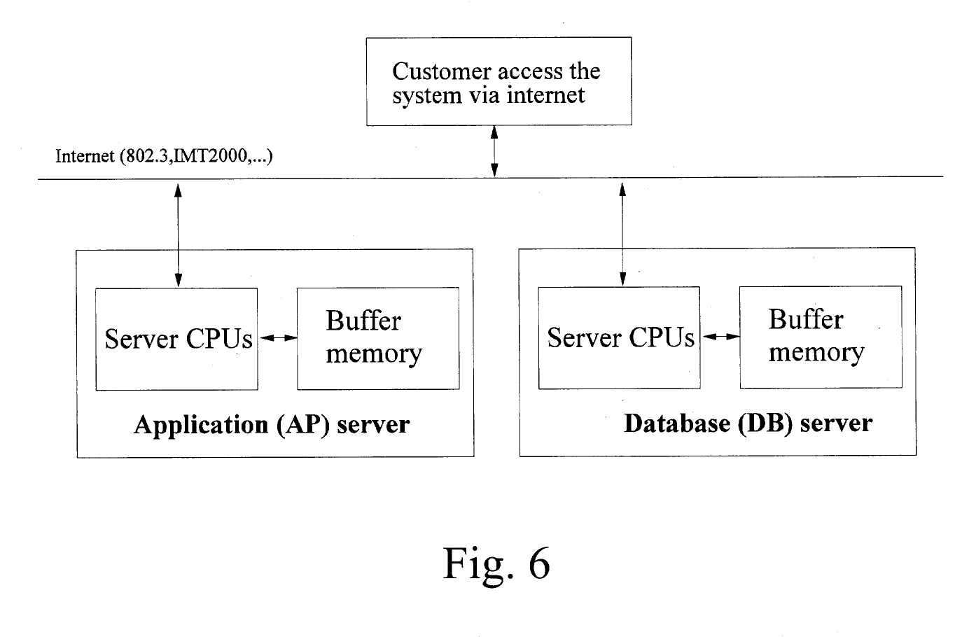

The system used as an example in this invention is a 3-tier client/server infrastructure as in FIG. 6, which is widely used in the area of multi-media and on-line game. The large amount of network data transactions causes stringent challenge in system design. Meanwhile, the system availability is one of the key factors to the revenue of the system user. Accordingly, such an availability requirement imposes stringent challenge on the system design, customer service and supply chain resource allocation. This will need a conceptual design stage trade-off for a balance as in FIG. 1. We demonstrate our idea as following.

In FIG. 6, customers who access the system through internet, the hardware and software environment and failures produce demands, while the system itself, supply .chain and the customer service infrastructure combined to provide resources to fulfill the demands. As in FIG. 6, let i represent the category of the customer's action (for example, i=1 means personal data enquiry). The number of category of the customer's action and the probability model of having one such a category of action occurred come from market survey and requirement analysis. Now assume that we only have one category of customer action, i.e. i=1.

The operational scenario of having a customer enquiry occurred and processed are assumed as following:

1. The customer initiates one enquiry at the web browser, after τ₁ᵢ seconds of processing time, an action commend of n₁ᵢ packets is generated. Then it will be sent to the AP server through the Ethernet by UDP protocol.

2. When the AP server received said action commend of n₁ᵢ packets, if there is an idle CPU available, then said action commend of n₁ᵢ packets will be processed immediately, if not, then it will go to a queuing buffer memory. After τ₂ᵢ seconds CPU processing time plus possible queuing time, a n₂ᵢ-packet data-request commend is generated. Then it will be sent out to the Database server via Ethernet with UDP protocol. Should there is any queued action commend or data needs to be processed in the buffer memory, it will be retrieved to be processed in a first-in-first-out policy.

3. When the Database server received said n₂ᵢ-packet data-request commend from the AP server, by following the similar operational scenario of the second scenario stated above, it takes τ₃ᵢ seconds CPU processing time plus possible queuing time to generate a n₃ᵢ-packet data. Then it will be sent out to the AP server via Ethernet with UDP protocol.

4. When the AP server received said n₃ᵢ-packet data from the Database server, by following the similar operational scenario of the second scenario stated above, it takes τ₄ᵢ seconds CPU processing time plus possible queuing time to generate a n₄ᵢ-packet response. Then it will be sent out to the customer's terminal via Ethernet with UDP protocol. When the customer terminal received said n₄i-packet response, an enquiry is completed.

5. If any packet is missed during these procedures, the enquiry transaction will be deemed as failed and no response will be given to the customer.

6. When the object server's capacity is full so that commends or data cannot enter, the enquiry transaction will be deemed as failed and no response will be given to the customer.

7. Considering the time for the network to reach a steady state and our calculation cost, we only study the network traffic within 90 seconds without losing the generality. The price to calculate a 90-second network traffic history is within an acceptable range as explained following.

8. The length of each packet is assumed to be 1540 bytes.

The system operation, maintenance and customer service mechanism are assumed as following:

1. The system is a modular design whose modules are subject to be failed randomly during operation with a certain probability model. Some module failures or their combination will cause the system shut down.

2. Each module has only two states, which are normal or failed.

3. System user has a spare module inventory stock. Once there is a module failed, it will be removed and replaced with a spare one from the inventory. The failed module will be sent to its vendor for repairing. After a certain turn around time (TAT), the repaired module will be sent back to the user as a new spare.

4. Every repair task has its expenditure cost.

5. The TAT and cost of repairing depend on the brand and the vendor chosen.

6. System shutdown will incur revenue loss which is deemed as an opportunity cost.

Hardware and software specification are assumed as following

1 The AP server and the Database have m_{AP} and m_{DB} parallel CPUs respectively, while the buffer memory can host Q_{AP} and Q_{DB} commends or data.

2 There are various vendors who can provide modules with various brand and features to construct the system.

3 We have 10M bps (bits per second) and 100M bps for bandwidth options.

Mathematical models are as following:

1. Models of customer demand: The probability model of having an i^{th} category customer action in time domain is assumed as P_customer₁ᵢ (t| t′) which can be obtained from market survey or requirement analysis. P_customer₁ᵢ (t| t′) is the probability of having a new i^{th} category customer action at the moment t given that there happened a customer action at the moment t′. The performance of the network infrastructure is represented by the waiting time before receiving the response and the probability of receiving response successfully. These two parameters are dynamic functions of the probability model of having a customer action, which can be obtained from the market survey and strategy, and the system design. Whenever there occurs a customer action, it is assigned a unique serial number starting from 1 which is w ( i )=1, 2, 3, . . . , to represent the w(i)^{th} action of the i^{th} category. From the design information, we learn that when said action will cause an action commend of n₁ᵢ packets being sent to the AP server. The incurred network load can be modeled as P_{1iw(i)Bw(i)j} (t| t′) , which means the probability of transmitting the j^{th} packet of said action commend at the moment t given that there happened a packet transmission at the moment t′. Here Bw(i) is a status index and j=1˜n₁ᵢ represents the j^{th} packet of said action commend of n₁ᵢ packets. For j=1, it means starting to send out the first packet, and for j=n₁ᵢ, it means that the last packet has been sent out.

2. Models of AP server function:

A. When said action commend of n₁ᵢ packets enters the AP server from the customer terminal, it will search for an idle CPU to be processed. If there are several idle CPUs, then choose the one with least priority. Suppose the k^{th}. CPU (k=1˜M_{AP}) is chosen. From the design information, we learn that when the CPU completed said action commend, a n₂ᵢ-packet data-request commend will be generated and sent to the Database server, while the incurred network load model will be assigned as P_{2iw(i)Bw(i)jk} (t| t′). If all the CPUs are busy and the buffer memory reaches it full capacity when said action commend arrived, then said action will be dropped while the number of dropped i^{th} category action, F_No(i), will be incremented by 1 and Bw(i) will be reset. When packets start to be sent to the Database server, we count j=1˜n₂ᵢ.

B. When said n₃ᵢ-packet data requested by said n₂ᵢ-packet data-request commend enters the AP server from the Database server, it follows the same processing procedures as stated above. Suppose the k^{th}. CPU (k=1˜M_{AP}) is chosen. Similarly, when the CPU completed the data processing task, a response of n₄ᵢ packets will be generated and sent to the customer, while the incurred network load model will be assigned as P_{4iw(i)Bw(i)jk} (t| t′). If all the CPUs are busy and the buffer memory reaches it full capacity when said data requested by said data-request commend arrived, then said action will be dropped while the number of dropped i^{th} category action, F_No(i), will be incremented by 1 and Bw(i) will be reset. When packets start to be sent to the Database server, we count j=1˜n₄ᵢ.

3. Models of Database server:

When said n₂ᵢ-packet data-request commend enters the Database server from the AP server, it follows the same processing procedure as stated above. Suppose the k^{th}. CPU (k=1˜M_{DB}) is chosen. Similarly, when the CPU completed the processing task, a n₃ᵢ-packets data will be generated and sent to the AP server, while the incurred network load model will be assigned as P_{3iw(i)Bw(i)jk} (t| t′). If all the CPUs are busy and the buffer memory reaches it full capacity when said data-request commend arrived, then said action will be dropped. while the number of dropped i^{th} category action, F_No(i), will be incremented by 1 and Bw(i) will be reset. When packets start to be sent to the customer, we count j=1˜n₃ᵢ.

4. P_{hiw(i)Bw(i)jk} is subject to change in accordance with the specification and operational scenario.

5. There will be only one event allowed to happen at any time moment while each event occurs independently.

6. System logistic support models:

A. Reliability models:

I. The probability models of failure for the CPUs of the AP server and the Database server are PF1_{CPU} (t|t′) and PF2_{CPU} (t|t′) respectively, which mean the probability of a CPU being failed at the moment t given that it being normal at the moment t′.

II. The probability models of failure for the memory modules of the AP server and the Database server are PF1_{RAM} (t|t′) and PF2_{RAM} (t|t′) respectively.

B. Maintainability models:

I. The probability models of repair for the CPUs of the AP server and the Database server are PM1_{CPU} (t|t′) and PM2_{CPU} (t|t′) respectively, which mean the probability of a CPU being repaired at the moment t given that it failed at the moment t′.

II. The probability models of repair for the memory modules of the AP server and the Database server are PM1_{RAM} (t|t═) and PM2_{RAM} (t|t′) respectively.

The above reliability and maintainability information can be obtained from the vendors or manufacturers of the modules.

C. From failure mode effect and criticality analysis (FMECA) we obtain the true-false table of the system status vs. modules' states.

D. System availability model:

Ao=accumulated time when the system is normal/studied system life time

7. Cost models:

A. Expenditures incurred from system operation and maintenance plus the investment of system acquisition become the life cycle cost (LCC).

B. Revenue loss incurred from system unavailability plus the LCC stated above become the life cycle revenue loss (LCRL).

The above information can be obtained form the system user's business process, supply chain infrastructure and market survey.

E System configuration options:

1. Option 1:

A. Functional parameters:

τ₁₁˜=0, n₁₁=2, τ₂₁=0.75, n₂₁=3, τ₃₁=0.1, n₃₁=5, τ₄₁=0.15, n₄₁=6, M_{AP}=1, M_{DB}=1, Q_{AP}=Q_{DB}=10, the bandwidth is 10 Mbps.

B. Hardware configuration:

I. AP server: one A brand CPU+ one A brand memory module ∘

II. Database server: one A brand CPU+ one A brand memory module ∘

C. Reliability:

I. A brand CPU: exponential distribution with constant failure rate λ=10⁻³ (1/hour).

II. A brand memory module: exponential distribution with constant failure rate λ=10⁻⁴ (1/hour).

D. FMECA:

Only when all modules are normal that the system is normal.

E. Unit prices:

I. A brand CPU: 300000 dollars∘

II. A brand memory module: 250000 dollars∘

F. Maintenance policy and its cost:

All modules have go-no-go built-in-test with hot plug and play feature. The repair TAT of an A brand modules is 76 hours while the cost is 600 dollars.

G. Spare inventory:

Three A brand CPUs+two A brand memory modules∘

2. Option 2:

A. Functional parameters: the same as in Option 1

B. Hardware configuration:

I. AP server: two parallel A brand CPUs+one A brand memory module.

II. Database server: one A brand CPU+one A brand memory module.

C. Reliability: the same as in Option 1.

D. FMECA:

I. Only when all modules of Database server are normal state that the system is normal.

II. Two parallel AP server CPUs work as redundancy, so that the system will be normal with at least one AP server CPU being normal while all other modules are normal.

E. Unit prices: the same as in Option 1.

F. Maintenance policy and its cost: the same as in Option 1.

G. Spare inventory: the same as in Option 1.

3. Option 3:

A. Functional parameters:

$${τ}_{11} ∼ = 0 , {n}_{11} = 2 , {τ}_{21} = 0.375 , {n}_{21} = 3 , {τ}_{31} = 0.1 , \\ {n}_{31} = 5 , {τ}_{41} = 0.075 , {n}_{41} = 6 , {m}_{AP} = 1 , {m}_{DB} = 1 , {Q}_{AP} = {Q}_{DB} = \\ 10 , the bandwidth is 10 Mbps ∘$$

B. Hardware configuration

I. AP server: one B brand CPU+one A brand memory module.

II. Data base server: one A brand CPU+one A brand memory module.

C. Reliability:

B brand CPU: exponential distribution with constant failure rate λ=10⁻⁴ (1/hour).

D. FMECA: the same as in Option 1.

E. Unit price:

B brand CPU: 500000 dollars.

F. Maintenance policy and its cost:

The repair TAT of a B brand modules is 152 hours while other parameter are the same as in Option 1.

G. Spare inventory:

one A brand CPU+two B brand CPUs+two A brand memory modules∘

4. Option 4:

A. Functional parameters: the same as in Option 3.

B. Hardware configuration:

I. AP server: two parallel B brand CPUs+one A brand memory module.

II. Data base server: one A brand CPU+one A brand memory module.

C. Reliability: the same as in Option 3.

D. FMECA: the same as in Option 2.

E. Unit price: the same as in Option 3.

F. Maintenance policy and its cost: the same as in Option 3.

G. Spare inventory: the same as in Option 3.

Common assumptions:

1. Only CPU and memory module are critical modules whose failures may cause or combined to cause system shutdown.

2. When the system works normally, it may earn a revenue of 5000 dollars per hour. Such revenue estimation comes from the market survey.

3. The system works 24 hours a day, 365 days a year. The studied system life time is one year.

4. The spare inventory is subject to change in accordance with the actual problem.

All the above assumptions are arbitrary combinations for the sake of convenience in demonstrating our idea.

Model calculation:

The packet transaction, module failure and repair are independent events along the time axis. If the event to be happened is one of the Eₗ˜Eᵤ, while the probability density functions of having these events happened are Pₗ˜Pᵤ respectively. For the characteristic feature calculations of a specific option, we may concentrate on solving the following problems:

1. When will there be a packet transmission? By probability theory, given that there has been a packet transmission event at the moment t′, the joint probability of having a packet being sent out at the moment t=-t′+Δt will be :

$$P = [ {\int }_{0}^{Δ t} p1 ( τ ) ⅆ τ ] … [ {\int }_{0}^{Δ t} pi ( τ ) ⅆ τ ] … [ {\int }_{0}^{Δ t} pu ( τ ) ⅆ τ ]$$

which is a probability with value between 0 and 1. By generating a random number, η, whose value is between 0 and 1, and let η=P(t), we may obtain a random sample of Δt from the inverse function Δt=P⁻¹ (η).

2. The packet is sent out from which joint? Suppose at the moment τ=t′+Δt, some joint will send out a packet. The candidate joints are Gₗ˜Gᵤ, while the probabilities for each joint to send out a packet are PEₗ˜PE_{U} respectively. Let

$${Ψ}_{i} = [ {\sum }_{j = 1}^{i} {PE}_{j} ] / [ {\sum }_{k = 1}^{u} {PE}_{k} ]$$

where i=1˜u.

By generating a random number, ζ, whose value is between 0 and 1. Let Ψᵢ₋₁<ζ≦Ψᵢ, then it means that it is the Gᵢ joint that will send out a packet at the moment τ.

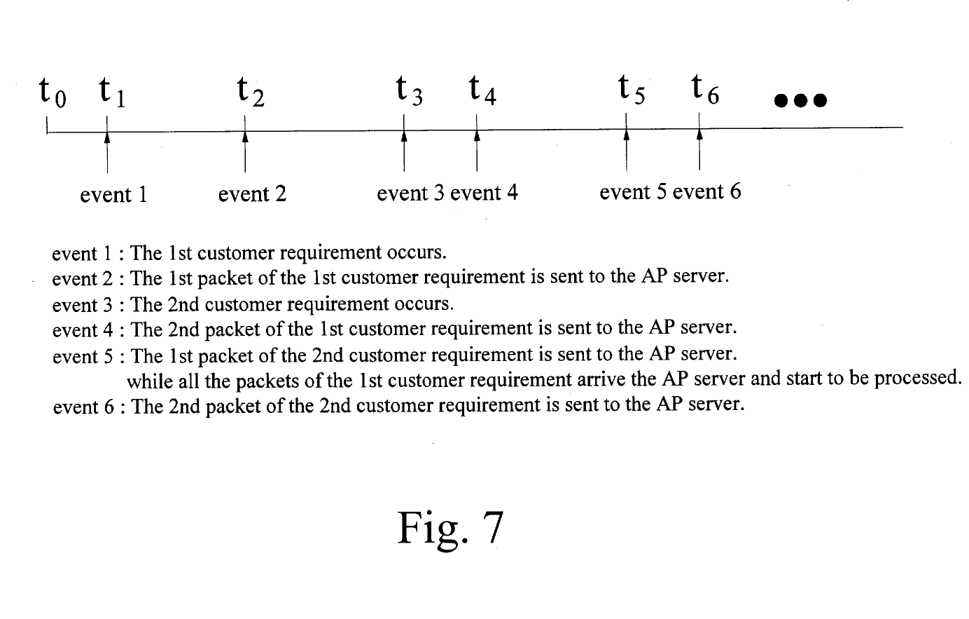

3. Repeat step 1 and 2 until the elapsed time is over Tm. Thus we obtain a sample of transaction history as shown in FIG. 7 from which the following parameters can be calculated:

A. The average response waiting time of each category of action, Tᵣₑₛₚₒₙₛₑ_{_{—}}ᵢ, where i=1, 2, 3, . . . ∘

B. The probability of success response:

P_{sucess}_{_{—}}ᵢ=[w(i)−F_No(i)]/w(i) where i=1, 2, 3, . . .

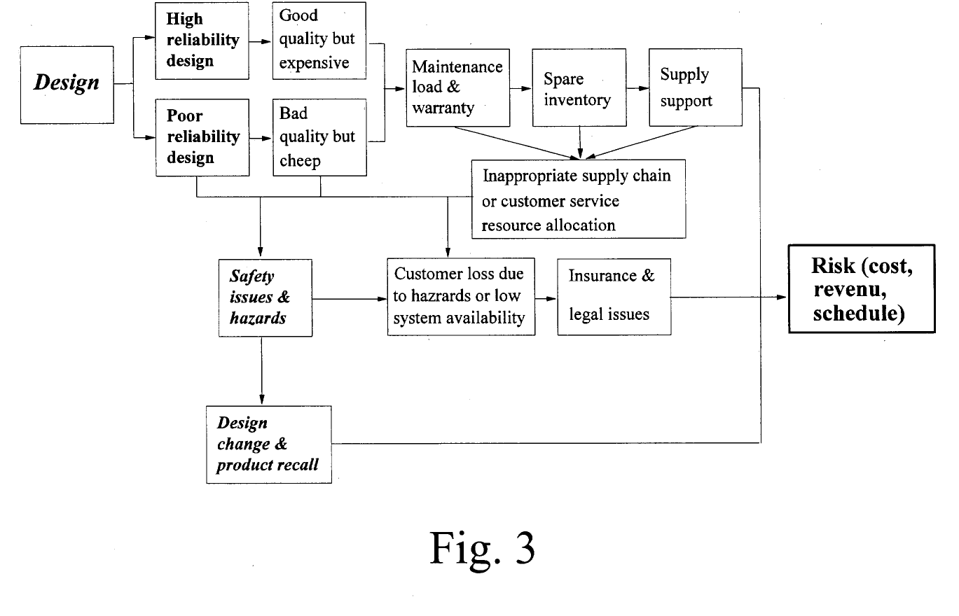

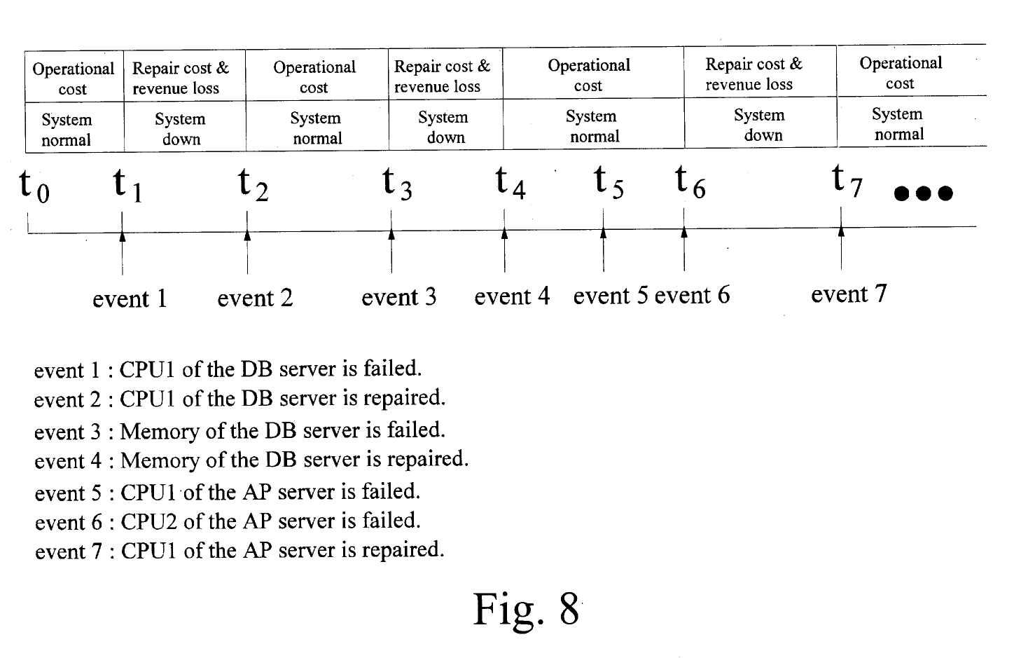

4. From FIG. 3, the failure drives the system life cycle feature and risk. Therefore our life cycle characteristics study of a specific option focus on determining when will there be a module failure, which module will be failed and when a failed module will be repaired under the constrains of supply and support resource allocation. Meanwhile, we also determine the system status at any moment in accordance with the modules states by the true-false table from FMECA. According to the system status and the module states, we put monetary value on every time intervals. Following procedure similar to step 3, we obtain a sample of system life cycle history as in FIG. 8.

5. For a specific option, repeat the above steps N times to obtain N samples of the characteristic parameters we are interested, such as Tᵣₑₛₚₒₙₛₑ_{_{—}}ᵢ, P_{sucess}_{_{—}}ᵢ., system availability Ao, LCC and LCRL. From these samples we may calculate the confidence intervals of these parameters for trade-off study.

6. Repeat the steps stated above for every options and put the calculation results together to trade off and demonstrate the design balance in FIG. 1.

Calculation and trade-off results:

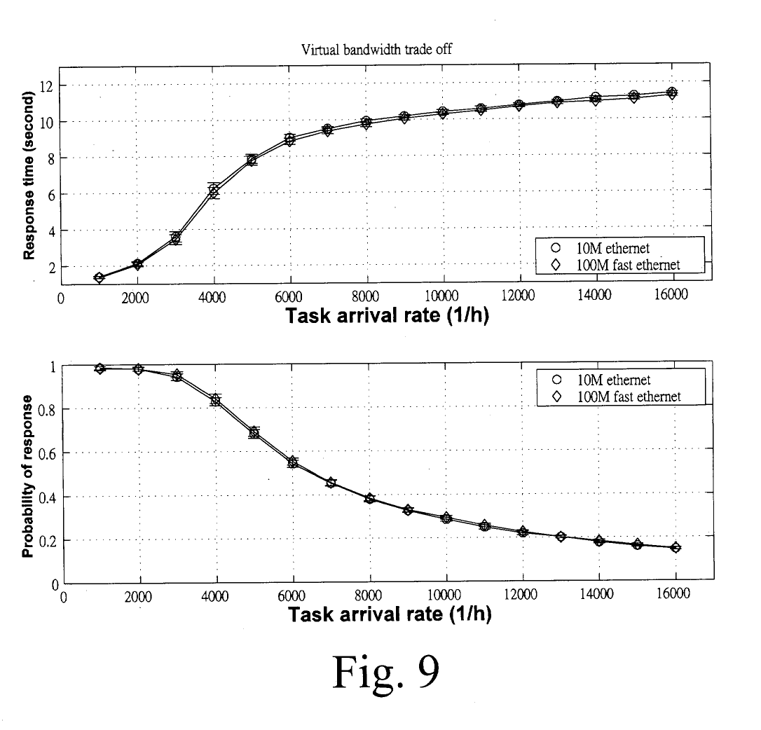

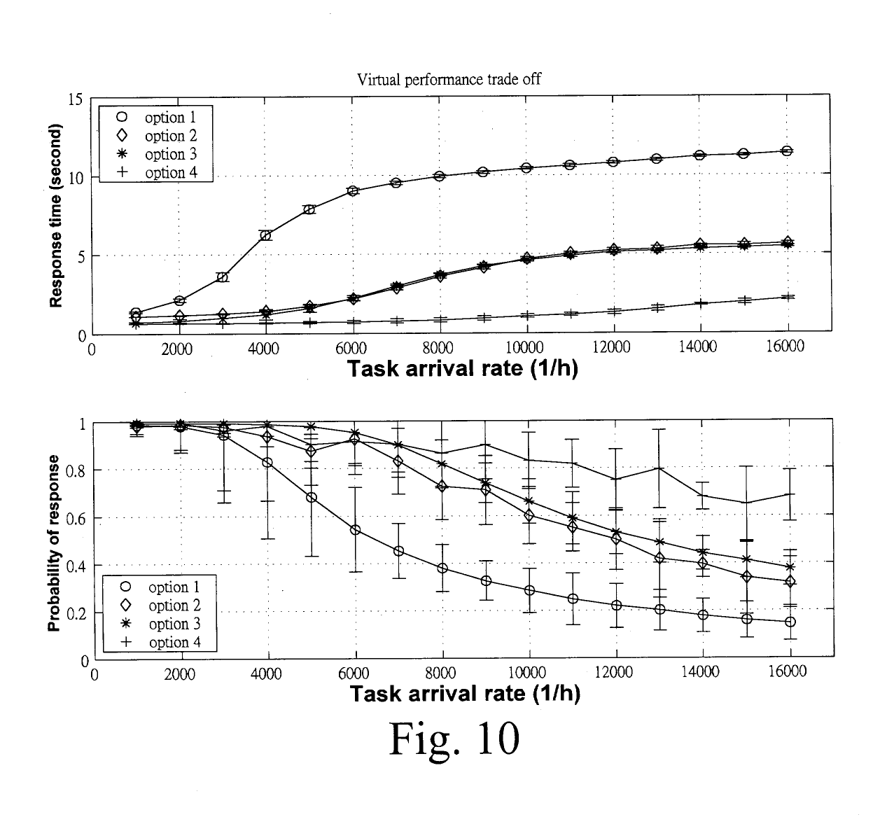

From the 100 network transaction histories of the Option 1, we obtain the trade-off profiles as in FIG. 9, which shows that the performance profiles of 10M bps and 100 M bps bandwidth are not statistically differentiable. Thus we choose the bandwidth of 10M bps for the rest of computations. The calculation results of performance profiles of those four options are shown in FIG. 10. From FIG. 10, we can see that the performance profiles of Option 2 and 3 are not statistically differentiable, but they all superior than the profile of Option 1 with significance. The Option 4 has the best performance profile with significance for heavy customer demand loads up to 16000 enquiries per hour.

Suppose the market survey predicts that the customer demand load will increase over 4000 enquiries per hour within a short time; then Option 4 will be the best choice. If the demand load will not grow up rapidly, then further trade-off for other features will be needed as following:

1. The reliability and quality of a B brand CPU are superior to those of an A brand CPU.

2. The maintainability and maintenance cost of a B brand CPU are superior to those of an A brand CPU.

3. The unit price of a B brand CPU is much higher than the price of an A brand CPU.

4. The B brand CPU cannot be acquired from the market easily while the A brand CPU can be easily acquired. So that the procurement lead time and the repair TAT of a B brand CPU are longer than those time requirements of an A brand.

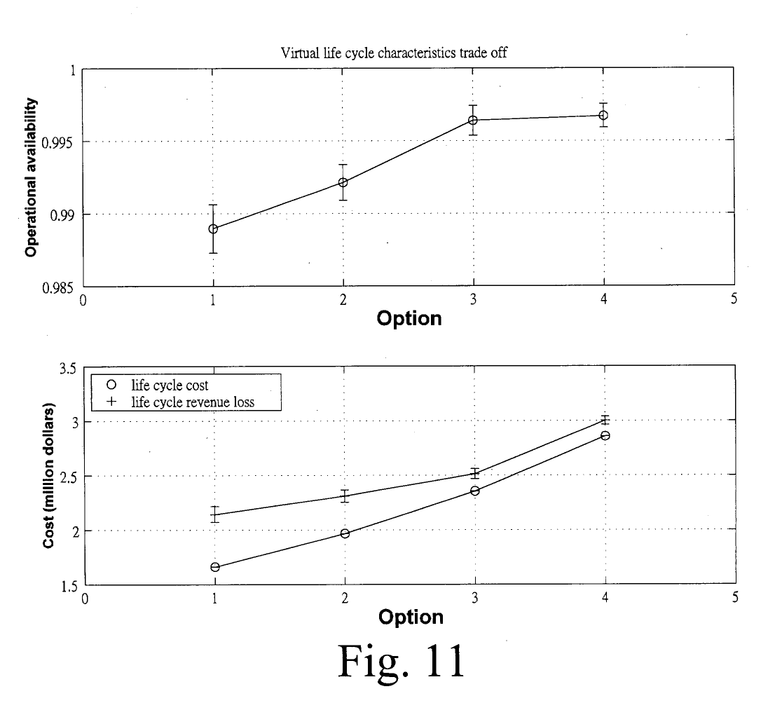

The calculation results of the life cycle characteristics of the four options are shown in FIG. 11. From the calculation results, we can see that the calculation results for availability Ao of the four options cannot be statistically differentiated. The maximum difference of LCC or LCRL is about one million dollars, which comes from the difference between the calculation results of Option 4 and Option 1. Such a cost difference is negligible when compared with the predicted revenue of 43 million dollars a year. Thus we may conclude that Option 4 is our best choice from the above trade-off results.

With our computing facility, a PC with Pentium III 1G Hz CPU, 512M byte 133 MHz SDRAM, Red Hat Linux 7.1, Octave version 2.1.33, it takes about 90 CPU hours to calculate the results shown in FIG. 9, about 178 CPU hours to calculate the results shown in FIG. 10 and about only 40 CPU seconds to calculate the results shown in FIG. 11, These computation times depend on the problem we are dealing with and the computing facility we use.

We have demonstrated our idea of using mathematical models to perform trade-off between various design options to reach a design balance as shown in FIG. 1. This method can reduce the risk of cost and schedule of a product R&D project with a comparatively low cost and increase the company's ability in adapting the rapid market change.

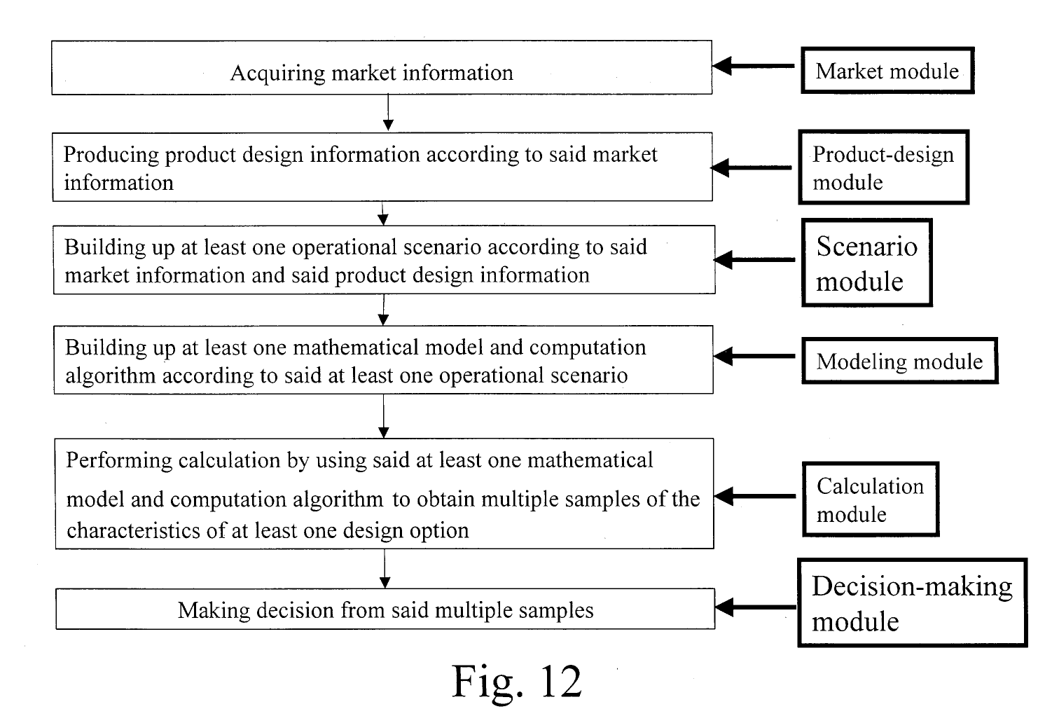

In summary, please referring to FIG. 12, which is a diagram depicting the flow chart of the integrated virtual product or service validation and verification method according to the present invention. As shown, the integrated virtual product or service validation and verification method of the present invention comprises the following steps:

(1) Acquiring market information;

(2) Producing product design information according to said market information;

(3) Building up at least one operational scenario according to said market information and said design information;

(4) Building up at least one mathematical model and computation algorithm according to said at least one operational scenario;

(5) Performing calculation by using said at least one mathematical model and computation algorithm;

(6) Repeating the step (1) to step (5) multiple times to obtain the multiple samples of the characteristics of at least one design option;

(7) Making decision from said multiple samples.

According to the above discussion, the present invention discloses an integrated virtual product or service validation and verification method, which extremely reduce the cost and the time in product design stage. Therefore, the present invention has been examined to be progressive, advantageous and applicable to the industry.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

1. An integrated virtual product or service validation and verification system and method, which comprising:
(a) a market module for acquiring market information;
(b) a product-design module for producing product design information according to said market information;
(c) a scenario module for building up at least one operational scenario according to said market information and said product design information;
(d) a modeling module for building up at least one mathematical model and computation algorithm according to said at least one operational scenario;
(e) a calculation module for performing calculation by using said at least one mathematical model and computation algorithm to obtain multiple samples of the characteristics of at least one design option;
(f) a decision-making module for making decision from said multiple samples.

2. The integrated virtual product or service validation and verification system and method as recited in claim 1, wherein said market information can be customer requirement information.

3. The integrated virtual product or service validation and verification system and method as recited in claim 1, wherein said market information can be resource information being used for said product or service.

4. The integrated virtual product or service validation and verification system and method as recited in claim 1, wherein said market information can be market competition information of said product or service.

5. The integrated virtual product or service validation and verification system and method as recited in claim 1, wherein said market information can be market assessment information of said product or service.

6. The integrated virtual product or service validation and verification system and method as recited in claim 1, wherein said product design information can be operational function information of said product or service.

7. The integrated virtual product or service validation and verification system and method as recited in claim 1, wherein said product design information can be operational procedure information of said product or service.

8. The integrated virtual product or service validation and verification system and method as recited in claim 1, wherein said product design information can be specification information of said product or service.

9. The integrated virtual product or service validation and verification system and method as recited in claim 1, wherein said product design information can be customer service mechanism information of said product or service.

10. The integrated virtual product or service validation and verification system and method as recited in claim 1, wherein said product design information can be the information which concerns the resources needed to implement an operational function of said product or service.

11. The integrated virtual product or service validation and verification system and method as recited in claim 1, wherein said product design information can be the information which concerns the resources needed to implement an operational procedure of said product or service.

12. The integrated virtual product or service validation and verification system and method as recited in claim 1, wherein said product design information can be the information which concerns the resources needed to implement a specification of said product or service.

13. The integrated virtual product or service validation and verification system and method as recited in claim 1, wherein said product design information can be the information which concerns the resources needed to implement a customer service mechanism of said product or service.

14. The integrated virtual product or service validation and verification system and method as recited in claim 1, wherein said operational scenario can include multiple characteristic changes of said product or service.

15. The integrated virtual product or service validation and verification system and method as recited in claim 1, wherein said characteristics of a design option can be the function of said product or service.

16. The integrated virtual product or service validation and verification system and method as recited in claim 1, wherein said characteristics of a design option can be the performance of said product or service.

17. The integrated virtual product or service validation and verification system and method as recited in claim 1, wherein said characteristics of a design option can be the life cycle overall characteristics of said product or service.

18. The integrated virtual product or service validation and verification system and method as recited in claim 1, wherein said characteristics of a design option can be the merit of said product or service.

19. The integrated virtual product or service validation and verification system and method as recited in claim 1, wherein said decision making can be made in a manual way.

20. The integrated virtual product or service validation and verification system and method as recited in claim 1, wherein said decision making can be made in a computerized way.
